(19) United States
(12) Patent Application Publication
(10) Pub. No.: US 2007/0239295 A1
(43) Pub. Date: Oct. 11, 2007

(54) Codec conditioning system and method

(76) Inventors: Jeffrey K. Thompson, Bothell, WA (US); Robert W. Reams, Mill Creek, WA (US); Aaron Warner, Seattle, WA (US)

Correspondence Address: Mr. Christopher John Rourk;Jackson Walker LLP, 901 Main Street, Suite 6000, DALLAS, TX, 75202, US

(21) Appl. No.: 11/710,070

(22) Filed: Feb. 23, 2007

Related U.S. Application Data
(60) Provisional application No. 60/776,373, filed on Feb. 24, 2006.

(51) Int. Cl. G06F 17/00

(52) U.S. Cl. 700/94

(57) ABSTRACT

An audio processing application is provided which utilizes an audio codec encode/decode simulation system and a psychoacoustic model to estimate audible quantization noise that may occur during lossy audio compression. Mask-to-noise ratio values are computed for a plurality of frequency bands and are used to intelligently process an audio signal specifically for a given audio codec. In one exemplary embodiment, the mask-to-noise ratio values are used to reduce the extent of perceived artifacts for lossy compression, such as by modifying the energy and/or coherence of frequency bands in which quantization noise is estimated to exceed the masking threshold.

### RELATED APPLICATIONS

This application claims priority to U.S. provisional application Ser. No. 60/776,373, filed Feb. 24, 2006, entitled “CODEC CONDITIONING SYSTEM AND METHOD,” which is hereby incorporated by reference for all purposes.

### FIELD OF THE INVENTION

The present invention pertains to the field of audio coder-decoders (codecs), and more particularly to a system and method for conditioning an audio signal to improve its performance in a system for transmitting or storing digital audio data.

### BACKGROUND OF THE INVENTION

Modern perceptual audio coding techniques exploit the masking properties of the human auditory system to achieve impressive compression ratios. The simultaneous masking property of the human auditory system is a frequency-domain phenomenon wherein a high intensity stimulus (i.e., masker) can prevent detection of a simultaneously occurring lower intensity stimulus (i.e., maskee) based on the frequencies and types (i.e., noise-like or tone-like) of masker and maskee. The temporal masking property of the human auditory system is a time-domain phenomenon wherein a sudden masking stimulus can prevent detection of other stimuli which are present immediately preceding (i.e., pre-masking) or following (i.e., post-masking) the masking stimulus. For a complex time-varying signal consisting of multiple maskers, a time-varying global masking threshold exists as a sophisticated combination of all of the masking stimuli.

Perceptual audio coders exploit these masking characteristics by maintaining that any quantization noise inevitably generated through lossy compression remains beneath the global masking threshold of the source audio signal, thus remaining inaudible to a human listener. A fundamental property of successful perceptual audio coding is the ability to dynamically shape quantization noise such that the coding noise remains beneath the time-varying masking threshold of the source audio signal.

Psychoacoustic research has led to great advances in audio codecs and auditory models, to the point where transparent performance can be claimed at medium data rates (e.g., 96 to 128 kbps). However, for many applications where data bandwidth is precious, such as satellite or terrestrial digital broadcast, Internet streaming, and digital storage, the coding artifacts resulting from low data rate compression (e.g., 64 kbps and less) remain an important problem.

### SUMMARY OF THE INVENTION

In accordance with the present invention, a system and method for processing audio signals are provided that overcome known problems with low data rate lossy audio compression.

In particular, a system and method for conditioning an audio signal specifically for a given audio codec are provided that utilize codec simulation tools and advanced psychoacoustic models to reduce the extent of perceived artifacts generated by the given audio codec.

In accordance with an exemplary embodiment of the present invention, an audio processing/conditioning application is provided which utilizes a codec encode/decode simulation system and a human auditory model. In one exemplary embodiment, a codec encode/decode simulation system for a given codec and a psychoacoustic model are used to compute a vector of mask-to-noise ratio values for a plurality of frequency bands. This vector of mask-to-noise ratio values can then be used to identify the frequency bands of the source audio which contain the most audible quantization artifacts when compressed by a given codec. Processing of the audio signal can be focused on those frequency bands with the highest levels of perceivable artifacts such that subsequent audio compression may result in lessened levels of perceivable distortions. Some potential processing methods could consist of attenuation or amplification of the energy of a given frequency band, and/or modifications to the coherence or phase of a given frequency band.

The present invention provides many important technical advantages. One important technical advantage of the present invention is a system and method for analyzing audio signals such that perceptible quantization artifacts can be simulated and estimated prior to encoding. The ability to pre-estimate audible quantization artifacts allows for processing techniques to modify the audio signal in ways which reduce the extent of perceived artifacts generated by subsequent audio compression.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a codec conditioning system in accordance with an exemplary embodiment of the present invention; and

FIG. 2 is a diagram of a codec conditioning system in accordance with an exemplary embodiment of the present invention; and

FIG. 3 is a diagram of a codec conditioning system in accordance with an exemplary embodiment of the present invention; and

FIG. 4 is a diagram of an intensity spatial conditioning system in accordance with an exemplary embodiment of the present invention; and

FIG. 5 is a diagram of a coherence spatial conditioning system in accordance with an exemplary embodiment of the present invention; and

FIG. 6 is a flow chart of a method for codec conditioning in accordance with an exemplary embodiment of the present invention; and

FIG. 7 is a flow chart of a method for conditioning an audio signal in accordance with an exemplary embodiment of the present invention.

### DETAILED DESCRIPTION OF PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

In low data rate audio coding, it is common for the number of bits required to transparently code a given audio frame to exceed the number of bits available for that frame. That is, more bits are required to keep the quantization noise below the human auditory system's masking threshold than are allocated. This means that quantization noise can now be perceptible and artifacts can potentially be heard.

When transparent coding of audio frames requires more bits than are available, the audio coder's bit allocation process must distribute a limited number of bits among many frequency bands. This bit allocation process is extremely important, as it ultimately affects the extent to which artifacts will be perceived by the listener.

For audio signals consisting of two or more channels (e.g., stereo signals, 5.1 signals) and for corresponding stereo or multichannel codecs, the spatial characteristics of the multichannel audio can also affect coding efficiency. Most modern low data rate codecs use some form of parametric spatial coding to improve coding efficiency (e.g., parametric stereo coding within MPEG HE-AAC), wherein multiple audio channels are combined to a lesser number of channels and coded with additional parameters which represent the spatial properties of the original signal. The relative intensity levels and coherence characteristics per frequency band are typically estimated prior to the channels being combined and are sent along as part of the coded bit stream to the decoder. Using the coded intensity and coherence parameters, the decoder attempts to re-apply and reproduce the original signal's spatial characteristics. Traditionally, attempting to model and parameterize audio signals for compression has been difficult due to the arbitrary nature of general audio signals and the vast array of signal types. Likewise, most low data rate audio codecs also have a difficult time modeling the sophisticated spatial elements of complex multichannel signals and frequently generate audible artifacts when attempting to parameterize and reproduce complex sound fields.

Furthermore, most audio codecs have inherent strengths and weaknesses or are tuned to fulfill certain tradeoffs and requirements. That is, most codecs have certain signal types (e.g., tonal signals, noise-like signals, speech, transient signals, etc.) that can be coded efficiently and transparently and other signal types that are coded inefficiently and which abound with artifacts. Under low data rate conditions, codec weaknesses are amplified and care should be taken to control the input signal characteristics such that poorly performing signal types are avoided.

Based on the non-optimal performance of most codecs and bit allocation processes in low data rate signals, especially across various signal types, a codec conditioning methodology for reducing the extent of perceived artifacts in low data rate audio coding is described. The methodology includes a codec simulation system for analysis and processing of an input signal. To provide optimal results, this codec simulation system should closely match the target audio codec intended for subsequent broadcast, streaming, transmission, storage, or other suitable application. Ideally, the codec simulation system should include a full encode/decode pass of the target audio codec. Audio codecs such as MPEG 1-Layer 2 (MP2), MPEG 1-Layer 3 (MP3), MPEG AAC, MPEG HE-AAC, Microsoft Windows Media Audio (WMA), or other suitable codecs, are exemplary target codecs that can utilize this method of conditioning. Likewise, if the noise characteristics of a transmission medium are known and can be simulated, such transmission noise simulations could also be used within this conditioning methodology, where suitable.

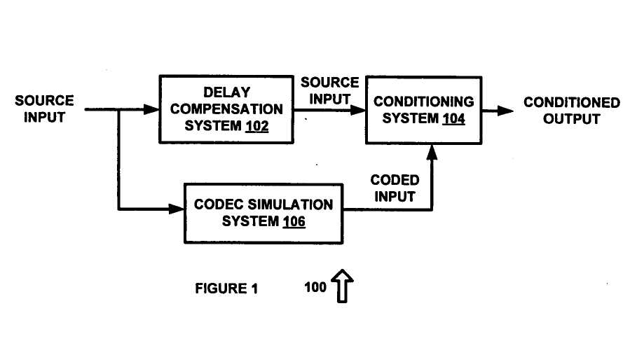

FIG. 1 is a diagram of a codec conditioning system 100 in accordance with an exemplary embodiment of the present invention. Codec conditioning system 100 can be implemented in hardware, software, or a suitable combination of hardware and software, and can be one or more discrete devices, one or more systems operating on a general purpose processing platform, or other suitable systems. As used herein, a hardware system can include a combination of discrete components, an integrated circuit, an application-specific integrated circuit, a field programmable gate array, or other suitable hardware. A software system can include one or more objects, agents, threads, lines of code, subroutines, separate software applications, two or more lines of code or other suitable software structures operating in two or more software applications or on two or more processors, or other suitable software structures. In one exemplary embodiment, a software system can include one or more lines of code or other suitable software structures operating in a general purpose software application, such as an operating system, and one or more lines of code or other suitable software structures operating in a specific purpose software application.

The source audio signal is sent through codec simulation system 106, which produces a coded audio signal to be used as a coded input to conditioning system 104. For optimal performance, codec simulation system 106 should closely match the target transmission medium or audio codec, ideally consisting of a full encode/decode pass of the target transmission channel or audio codec. In parallel, the source audio signal is delayed by delay compensation system 102, which produces a time-aligned source audio signal to be used as a source input to conditioning system 104. The source audio signal is delayed by delay compensation system 102 by an amount of time equal to the latency of codec simulation system 106. Conditioning system 104 uses both the delayed source audio signal and coded audio signal to estimate the extent of perceptible quantization noise that will have been introduced by an audio codec, such as by comparing the two signals in a suitable manner. In one exemplary embodiment, the signals can be compared based on predetermined frequency bands, in the time or frequency domains, or in other suitable manners. In another exemplary embodiment, critical bandwidths of the human auditory system, measured in units of Barks, can be used as a psychoacoustic foundation for comparison of the source and coded audio signals. Critical bandwidths are a well known approximation to the non-uniform frequency resolution of the human auditory filter bank.

In one exemplary embodiment, the Bark scale ranges from 1 to 24 Barks, corresponding to the first 24 critical bands of human hearing. The exemplary Bark band edges are given in Hertz as 0, 100, 200, 300, 400, 510, 630, 770, 920, 1080, 1270, 1480, 1720, 2000, 2320, 2700, 3150, 3700, 4400, 5300, 6400, 7700, 9500, 12000, 15500. The exemplary band centers in Hertz are 50, 150, 250, 350, 450, 570, 700, 840, 1000, 1170, 1370, 1600, 1850, 2150, 2500, 2900, 3400, 4000, 4800, 5800, 7000, 8500, 10500, 13500. In this exemplary embodiment, the Bark scale is defined only up to 15.5 kHz. Additional Bark band-edges can be utilized, such as by appending the values 20500 Hz and 27000 Hz to cover the full frequency range of human hearing, which generally does not extend above 20 kHz.

In conditioning system 104, after the extent of audible quantization noise has been estimated, processing techniques can be applied to the source audio signal to help reduce the extent of perceived artifacts generated by subsequent audio compression.

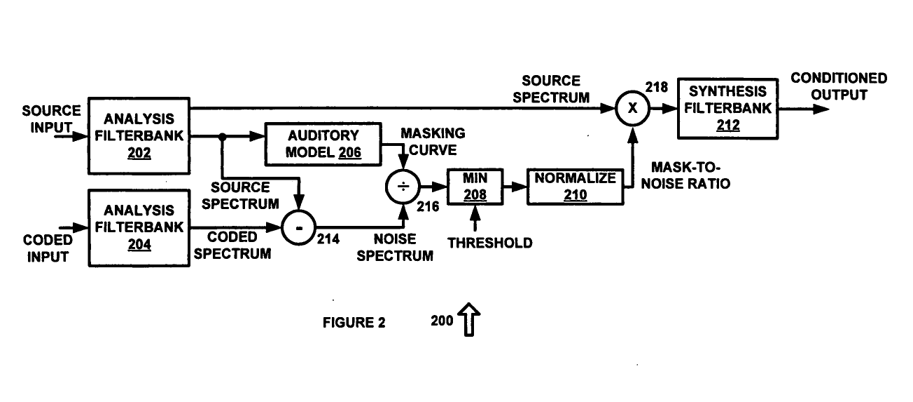

FIG. 2 is a diagram of a codec conditioning system 200 in accordance with an exemplary embodiment of the present invention. Codec conditioning system 200 can be implemented in hardware, software, or a suitable combination of hardware and software, and can be one or more discrete devices, one or more systems operating on a general purpose processing platform, or other suitable systems.

Codec conditioning system 200 provides an exemplary embodiment of conditioning system 104, but other suitable frameworks, systems, processes or architectures for implementing codec conditioning algorithms can also or alternatively be used.

The time-aligned source and coded audio signals are first passed through analysis filter banks 202 and 204, respectively, which convert the time-domain signals into frequency-domain signals. These frequency-domain signals are subsequently grouped into one or more frequency bands which approximate the perceptual band characteristics of the human auditory system. These groupings can be based on Bark units, critical bandwidths, equivalent rectangular bandwidths, known or measured noise frequencies, or other suitable auditory variables. The source spectrum is input into auditory model 206 which models a listener's time-varying detection thresholds to compute a time-varying spectral masking curve signal for a given segment of audio. This masking curve signal characterizes the detection threshold for a given frequency band in order for that band to be just perceptible, or more importantly, characterize the maximum amount of energy a given frequency band can have and remain masked and imperceptible.

A quantization noise spectrum is calculated by subtracting the source spectrum from the coded spectrum for each of the one or more frequency bands using subtractor 214. If the coded signal contains no distortions and is equal to the source signal, the spectrums will be equal and no noise will be represented. Likewise, if the coded signal contains significant distortions and greatly differs from the source signal, the spectrums will differ and the one or more frequency bands with the greatest levels of distortion can be identified.

One factor that can be used to characterize the audibility of quantization artifacts is the relationship between the masking curve and the quantization noise. For each frequency band, a mask-to-noise ratio value can be computed by dividing the masking curve value by the quantization noise value using divider 216. This mask-to-noise ratio value indicates which frequency bands have quantization artifacts that should appear inaudible to a listener (e.g., mask-to-noise ratio values greater than 1), and which frequency bands have quantization artifacts that can be noticeable to a listener (e.g., mask-to-noise ratio values less than 1).

After the frequency bands that have audible quantization distortions are determined, the audio signal can be conditioned to reduce the audibility of that noise. For example, one exemplary approach is to weight the source audio signal by normalized mask-to-noise ratio values. The mask-to-noise ratio values are first compared to a predetermined threshold of system 208 (e.g., a typical threshold value is 1) such that the minimum of the mask-to-noise ratio values and the threshold are output per frequency band. The thresholded mask-to-noise ratio values are then normalized by normalization system 210 resulting in normalized mask-to-noise ratio values between 0 and 1. By multiplying the source spectrum by the normalized mask-to-noise ratio values using multiplier 218, the source signal can be attenuated proportionately by the amount that the noise exceeds the mask per frequency band, based on the observation that attenuating the source spectrum in the frequency bands that produce the most quantization noise will reduce the perceptual artifacts in that band on a subsequent coding pass. The result of this weighting is that the frequency bands where the quantization noise exceeds the masking curve by a predetermined amount get attenuated, whereas the frequency bands where the quantization noise remains under the masking curve by that predetermined amount receive no attenuation.

After the source spectrum has been weighted by the mask-to-noise ratio, the signal is sent through a synthesis filter bank 212, which converts the frequency-domain signal to a time-domain signal. This conditioned audio signal is then ready for subsequent audio compression as the signal has been intelligently shaped to reduce the perception of artifacts specifically for a given codec.

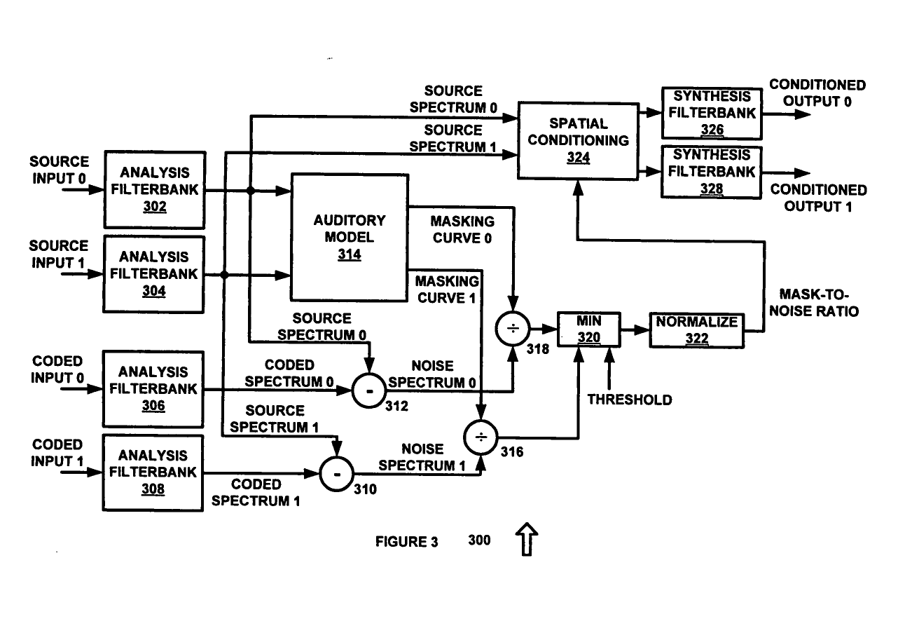

FIG. 3 is a diagram of a codec conditioning system 300 in accordance with an exemplary embodiment of the present invention. Codec conditioning system 300 can be implemented in hardware, software, or a suitable combination of hardware and software, and can be one or more discrete devices, one or more systems operating on a general purpose processing platform, or other suitable systems.

Codec conditioning system 300 provides an exemplary embodiment of conditioning system 104, but other suitable frameworks, systems, processes or architectures for implementing codec conditioning algorithms can also or alternatively be used.

Codec conditioning system 300 depicts a system for processing the spatial aspects of a multichannel audio signal (i.e., system 300 illustrates a stereo conditioning system) to lessen artifacts during audio compression. The stereo time-aligned source and coded audio signals are first passed through analysis filter banks 302, 304, 306, and 308, respectively, which convert the time-domain signals into frequency-domain signals. These frequency-domain signals are subsequently grouped into one or more frequency bands which approximate the perceptual band characteristics of the human auditory system. These groupings can be based on Bark units, critical bandwidths, equivalent rectangular bandwidths, known or measured noise frequencies, or other suitable auditory variables. The source spectrums are input into auditory model 314 which models a listener's time-varying detection thresholds to generate time-varying spectral masking curve signals for a given segment of audio. These masking curve signals characterize the detection threshold for a given frequency band in order for that band to be just perceptible, or more importantly, characterize the maximum amount of energy a given frequency band can have and remain masked and imperceptible.

Quantization noise spectrums are calculated by subtracting the stereo source spectrums from the stereo coded spectrums for each of the one or more frequency bands using subtractors 310 and 312. If the coded signals contain no distortions and are equal to the source signals, the spectrums will be equal and no noise will be represented. Likewise, if the coded signals contain significant distortions and greatly differ from the source signals, the spectrums will differ and the one or more frequency bands with the greatest levels of distortion can be identified.

One factor that can be used to characterize the audibility of quantization artifacts is the relationship between the masking curve and the quantization noise. For each frequency band, mask-to-noise ratio values can be computed by dividing the masking curve values by the quantization noise values using dividers 316 and 318. These mask-to-noise ratio values indicates which frequency bands have quantization artifacts that should appear inaudible to a listener (e.g., mask-to-noise ratio values greater than 1), and which frequency bands have quantization artifacts that can be noticeable to a listener (e.g., mask-to-noise ratio values less than 1).

After the frequency bands that have audible quantization distortions are determined, the audio signal can be conditioned to reduce the audibility of that noise. For example, one exemplary approach is to modify the spatial characteristics (e.g., relative channel intensity and coherence) of the signal based on the mask-to-noise ratio values. The mask-to-noise ratio values are first compared to a predetermined threshold of system 320 (e.g., a typical threshold value is 1) such that the minimum of the mask-to-noise ratio values and the threshold are output per frequency band. The thresholded mask-to-noise ratio values are normalized by normalization system 322 resulting in normalized mask-to-noise ratio values between 0 and 1. The normalized mask-to-noise ratio values are input to spatial conditioning system 324 where those values are used to control the amount of spatial processing to employ. Spatial conditioning system 324 simplifies the spatial characteristics of certain frequency bands when the quantization noise exceeds the masking curve by a predetermined amount, as simplifying the spatial aspects of complex audio signals can reduce perceived coding artifacts, particularly for codecs which exploit spatial redundancies such as parametric spatial codecs.

After the spatial characteristics of the source spectrums have been modified, the signals are sent through synthesis filter banks 326 and 328, which convert the frequency-domain signals to time-domain signals. The conditioned stereo audio signal is then ready for subsequent audio compression as the signal has been intelligently processed to reduce the perception of artifacts specifically for a given codec.

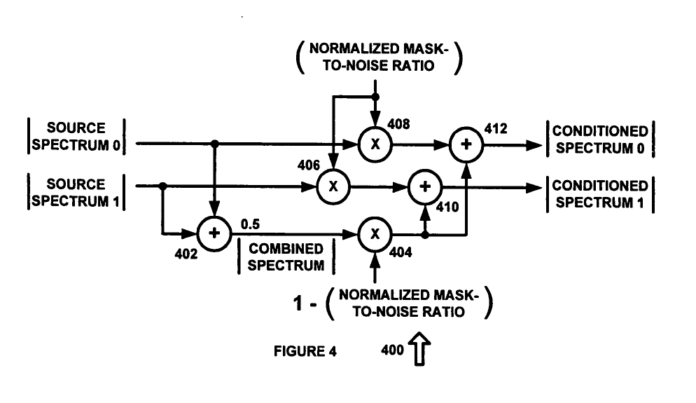

FIG. 4 is a diagram of an intensity spatial conditioning system 400 in accordance with an exemplary embodiment of the present invention. Intensity spatial conditioning system 400 can be implemented in hardware, software, or a suitable combination of hardware and software, and can be one or more discrete devices, one or more systems operating on a general purpose processing platform, or other suitable systems.

Intensity spatial conditioning system 400 provides an exemplary embodiment of spatial conditioning system 324, but other suitable frameworks, systems, processes or architectures for implementing spatial conditioning algorithms can also or alternatively be used.

Intensity spatial conditioning system 400 conditions the spatial aspects of a multichannel audio signal (i.e., system 400 illustrates a stereo conditioning system) to lessen artifacts during audio compression. A NORMALIZED MASK-TO-NOISE RATIO signal with values between 0 and 1 is used to control the amount of processing to perform on each frequency band. The power spectrums (i.e., magnitude or magnitude-squared) of the stereo input spectrums are first summed by summer 402 and multiplied by 0.5 to create a mono combined power spectrum. The combined power spectrum is weighted by the (1-(NORMALIZED MASK-TO-NOISE RATIO)) signal by multiplier 404. Likewise the stereo power spectrums are weighted by the (NORMALIZED MASK-TO-NOISE RATIO) signal by multipliers 406 and 408. The conditioned power spectrums are then created by summing the weighted stereo power spectrums with the weighted mono combined power spectrum by summers 410 and 412.

In operation, intensity spatial conditioning system 400 generates mono power spectrum bands when the normalized mask-to-noise ratio values for a given frequency band are near zero, that is when the quantization noise in that band is high relative to the masking threshold. No processing is executed on a frequency band when the normalized mask-to-noise ratio values are near one and quantization noise is low relative to the masking threshold. This processing is desirable based on the observation that codecs, particularly spatial parametric codecs, tend to operate more efficiently when spatial properties are simplified, as in having a mono power spectrum.

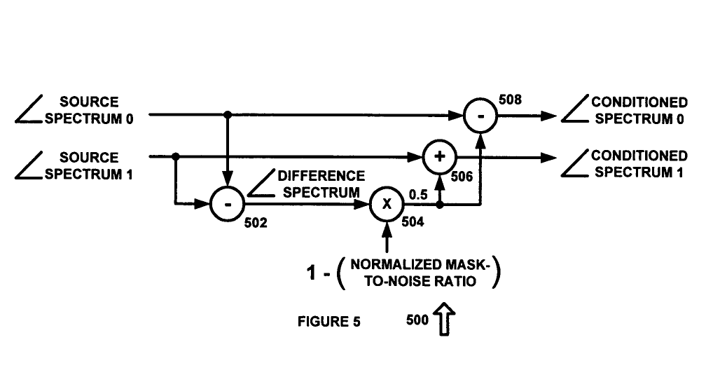

FIG. 5 is a diagram of a coherence spatial conditioning system 500 in accordance with an exemplary embodiment of the present invention. Coherence spatial conditioning system 500 can be implemented in hardware, software, or a suitable combination of hardware and software, and can be one or more discrete devices, one or more systems operating on a general purpose processing platform, or other suitable systems.

Coherence spatial conditioning system 500 provides an exemplary embodiment of spatial conditioning system 324, but other suitable frameworks, systems, processes or architectures for implementing spatial conditioning algorithms can also or alternatively be used.

Coherence spatial conditioning system 500 depicts a system that processes the spatial aspects of a multichannel audio signal (i.e., system 500 illustrates a stereo conditioning system) to lessen artifacts during audio compression. A NORMALIZED MASK-TO-NOISE RATIO signal with values between 0 and 1 can be used to control the amount of processing to perform on each frequency band. The phase spectrums of the stereo input spectrums are first differenced by subtractor 502 to create a difference phase spectrum. The difference phase spectrum is weighted by the (1-(NORMALIZED MASK-TO-NOISE RATIO)) signal by multiplier 504 and then multiplied by 0.5. The weighted difference phase spectrum is subtracted from the input phase spectrum 0 by subtractor 508 and summed with input phase spectrum 1 by summer 506. The outputs of subtractor 508 and summer 506 are the output conditioned phase spectrums 0 and 1, respectively.

In operation, coherence spatial conditioning system 500 generates mono phase spectrum bands when the normalized mask-to-noise ratio values for a given frequency band are near zero, that is when the quantization noise in that band is high relative to the masking threshold. No processing is executed on a frequency band when the normalized mask-to-noise ratio values are near one and quantization noise is low relative to the masking threshold. This processing is desirable based on the observation that codecs, particularly spatial parametric codecs, tend to operate more efficiently when spatial properties are simplified, as in having channels with equal relative coherence.

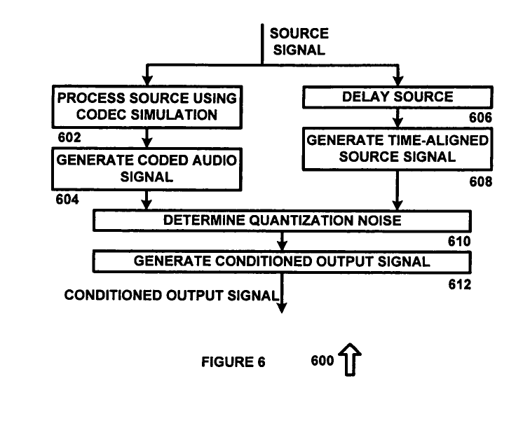

FIG. 6 is a flow chart of a method 600 for codec conditioning in accordance with an exemplary embodiment of the present invention.

Method 600 begins at codec simulation system 602, where the source audio signal is processed using an audio codec encode/decode simulation system. A coded audio signal to be used as a coded input to a conditioning process is then generated at 604.

The source audio signal is also delayed at 606 by a suitable delay, such as an amount of time equal to the latency of the codec simulation. The method then proceeds to 608 where a time-aligned source input is generated. The method then proceeds to 610.

At 610, the delayed source signal and coded audio signal are used to determine the extent of perceptible quantization noise that will have been introduced by audio compression. In one exemplary embodiment, the signals can be compared based on predetermined frequency bands, in the time or frequency domains, or in other suitable manners. In another exemplary embodiment, critical bands or frequency bands that are most relevant to human hearing, can be used to define the compared signals. The method then proceeds to 612.

At 612, a conditioned output signal is generated using the perceptible quantization noise determined at 610, resulting in an audio signal having improved signal quality and decreased quantization noise artifacts upon subsequent audio compression.

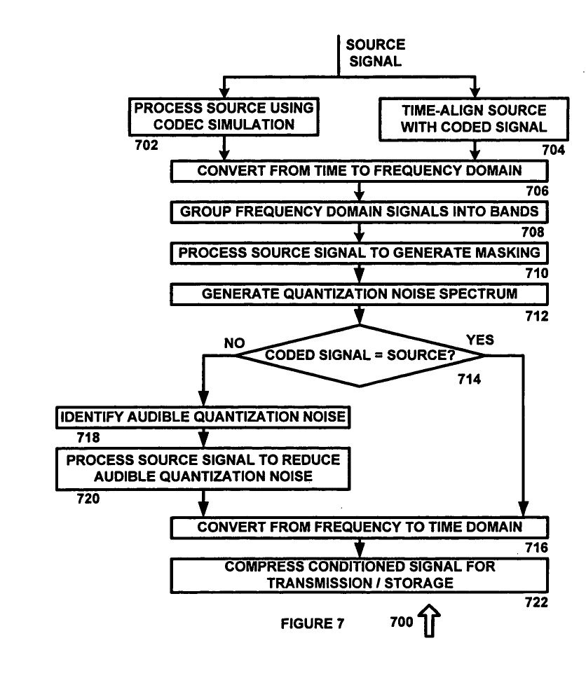

FIG. 7 is a flow chart of a method 700 for conditioning an audio signal in accordance with an exemplary embodiment of the present invention.

At 702, a source audio signal is processed using an audio codec encode/decode simulation system generating a coded audio signal. The source signal is also delayed and time-aligned with the coded audio signal at 704. The method then proceeds to 706, where the coded audio signal and time-aligned source signals are converted from time-domain signals into frequency-domain signals. The method then proceeds to 708.

At 708, the frequency-domain signals are grouped into one or more frequency bands. In one exemplary embodiment, the frequency bands approximate the perceptual band characteristics of the human auditory system, such as critical bandwidths. In another exemplary embodiment, critical bandwidths, equivalent rectangular bandwidths, known or measured noise frequencies, or other suitable auditory variables can also or alternately be used to group the frequency bands. The method then proceeds to 710.

At 710, the source spectral signal is processed using an auditory model that models a listener's perception of sound to generate a spectral masking curve signal for that arbitrary input audio. In one exemplary embodiment, the masking curve signal can characterize the detection threshold for a given frequency band in order for that band to be perceptible, the energy level a frequency band component can have and remain masked and imperceptible, or other suitable characteristics. The method then proceeds to 712.

At 712, a quantization noise spectrum is generated, such as by subtracting the source spectrum from the coded spectrum for each of the one or more frequency bands, or by other suitable processes. The method then proceeds to 714 where it is determined whether the coded signal is equal to the source signal. If it is determined that the spectrums are equal at 714, the method proceeds to 716. Otherwise, if the coded signal differs from the source signal by a predetermined amount the method proceeds to 718.

At 718, the audible quantization noise per frequency band is identified. In one exemplary embodiment, the audible quantization noise is characterized by the relationship between a masking curve and the quantization noise. In this exemplary embodiment, for each frequency band, the mask-to-noise ratio can be computed by dividing the masking curve by the quantization noise signal. The mask-to-noise ratio value indicates which frequency bands have quantization noise that should remain imperceptible (e.g., mask-to-noise ratios greater than 1), and which frequency bands have quantization noise that can be noticeable (e.g., mask-to-noise ratios less than 1). The method then proceeds to 720.

At 720, the audio signal is conditioned to reduce the audibility of the estimated quantization noise. For example, one exemplary approach is to weight the source audio signal by normalized mask-to-noise ratio values. The normalized mask-to-noise ratio values can be normalized differently for each frequency band, can be normalized similarly for all bands, can be dynamically normalized based on the audio signal characteristics (such as the mask-to-noise ratio), or can otherwise be normalized as suitable. In this exemplary embodiment, the mask-to-noise ratio is used to generate a frequency-domain filter in which the source spectrum is attenuated in frequency bands where quantization noise exceeds the masking curve, and unity gain is applied to frequency bands where quantization noise remains under the masking curve. In another exemplary embodiment, the spatial characteristics (e.g., relative channel intensity and coherence) of a source multichannel signal can be modified based on the mask-to-noise ratio values. This objective is based on the observation that simplifying the spatial aspects of complex audio signals can reduce perceived coding artifacts, particularly for codecs which exploit spatial redundancies such as parametric spatial codecs. The method then proceeds to 716.

At 716, the processed source spectrum signal is converted back from a frequency-domain signal to a time-domain signal. The method then proceeds to 722 where the conditioned audio signal is compressed for transmission or storage.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. A system for audio signal processing, comprising:
a reference audio codec simulation system receiving a source audio signal and simulating a coding and decoding system to generate a coded audio signal potentially including one or more coding artifacts;
a delay system delaying the source signal; and
a conditioning system receiving the source signal and the coded signal and generating a conditioned output signal that reduces the one or more coding artifacts when the conditioned output signal is subsequently coded and decoded.

2. The system of claim 1 wherein the conditioning system comprises a time domain to frequency domain conversion system.

3. The system of claim 1 wherein the conditioning system comprises an auditory model that generates a spectral masking curve.

4. The system of claim 3 wherein the spectral masking curve includes one or more frequency bands.

5. The system of claim 4 wherein the one or more frequency bands are comprised of one or more Barks.

6. The system of claim 1 wherein the conditioning system comprises a subtractor generating a noise spectrum.

7. The system of claim 1 wherein the conditioning system comprises a threshold system comparing the signal to a mask-to-noise ratio and attenuating the signal where quantization noise exceeds masking criteria.

8. The system of claim 1 wherein the conditioning system comprises a threshold system comparing one or more frequency bands of the signal to one or more frequency bands of a mask-to-noise ratio and attenuating the signal in frequency bands where quantization noise exceeds masking criteria.

9. The system of claim 1 wherein the conditioning system comprises a multiplier that multiplies the signal by a mask-to-noise ratio to attenuate the signal by an amount that a noise component of the reference signal exceeds a masking criteria.

10. The system of claim 1 wherein the conditioning system comprises conditioning means for receiving the reference signal and the delayed signal and generating a conditioned output signal that excludes the one or more coding artifacts when the conditioned output signal is coded and decoded.

11. A system for signal coding, comprising:
a reference codec system receiving a signal and generating a reference signal simulating a coded and decoded signal including one or more coding artifacts;
a delay system delaying the signal; and
a conditioning system receiving the reference signal and the delayed signal and generating a conditioned output signal that excludes the one or more coding artifacts when the conditioned output signal is coded and decoded, the conditioning system further comprising:
a time domain to frequency domain conversion system converting the reference signal and the delayed signal from a time domain to a frequency domain;
a perceptual model that generates a spectral masking curve of the delayed signal;
a subtractor generating a noise spectrum from the frequency domain reference signal and the frequency domain delayed signal;
a divider dividing the spectral masking curve with the noise spectrum to generate a mask-to-noise ratio; and
a threshold system comparing the frequency domain delayed signal to the mask-to-noise ratio and attenuating the frequency domain delayed signal where quantization noise exceeds the mask-to-noise ratio.

12. A method for signal coding, comprising:
receiving a signal and generating a reference signal simulating a coded and decoded signal that includes one or more coding artifacts;
delaying the signal; and
generating a conditioned output signal using the reference signal and the delayed signal that excludes the one or more coding artifacts when the conditioned output signal is coded and decoded.

13. The method of claim 12 wherein generating the conditioned output signal comprises performing a time domain to frequency domain conversion of the delayed signal and the reference signal.

14. The method of claim 12 wherein generating the conditioned output signal comprises processing the delayed signal using a perceptual model that generates a spectral masking curve.

15. The method of claim 12 wherein generating the conditioned output signal comprises generating a noise spectrum using the delayed signal and the reference signal.

16. The method of claim 12 wherein generating the conditioned output signal comprises comparing the delayed signal to a mask-to-noise ratio and attenuating the delayed signal where quantization noise exceeds masking criteria.

17. The method of claim 12 wherein generating the conditioned output signal comprises comparing one or more frequency bands of the delayed signal to one or more frequency bands of a mask-to-noise ratio and attenuating the delayed signal in frequency bands where quantization noise exceeds masking criteria.

18. The method of claim 12 wherein generating the conditioned output signal comprises multiplying the delayed signal by a mask-to-noise ratio to attenuate the delayed signal by an amount that a noise component of the reference signal exceeds a masking criteria.

19. The method of claim 12 wherein generating the conditioned output signal comprises a conditioning step for receiving the reference signal and the delayed signal and generating a conditioned output signal that excludes the one or more coding artifacts when the conditioned output signal is coded and decoded.
